(19) United States
(12) Patent Application Publication
(10) Pub. No.: US 2017/0264964 A1
(43) Pub. Date: Sep. 14, 2017

(54) METHOD AND APPARATUS FOR SHARING CONTENTS

(71) Applicant: Samsung Electronics Co., Ltd., Gyeonggi-do (KR)

(72) Inventors: Su-Ha Yoon, Seoul (KR); Jin-Ho Song, Seoul (KR); Jin-Goo Lee, Seoul (KR); Myung-Su Kang, Seoul (KR); Jin-Gil Yang, Gyeonggi-do (KR); Eui-Chang Jung, Seoul (KR)

(73) Assignee: Samsung Electronics Co., Ltd.

(21) Appl. No.: 15/453,294

(22) Filed: Mar. 8, 2017

(30) Foreign Application Priority Data
Mar. 11, 2016 (KR) 10-2016-0029785

(51) Int. Cl. H04N 21/63; H04L 29/06

(52) U.S. Cl. CPC H04N 21/632; H04L 65/4069; H04L 65/1069; H04L 65/105; H04L 65/1059

(57) ABSTRACT

The present disclosure relates to an electronic device and methods for sharing contents. A first electronic device includes a communication interface, and a processor configured to obtain a request for running a content sharing service with a second electronic device, generate connection identification information using first user identification information corresponding to the first electronic device and second user identification information corresponding to the second electronic device, in response to the request, and transmit the connection identification information to a first external electronic device for providing the content sharing service between the first electronic device and the second electronic device, using the communication interface.

### PRIORITY

This application claims priority under 35 U.S.C. §119(a) to a Korean Patent Application filed in the Korean Intellectual Property Office on Mar. 11, 2016, and assigned Serial No. 10-2016-0029785, the entire disclosure of which is incorporated herein by reference.

### BACKGROUND

1. Field of the Disclosure

The present disclosure relates generally to a method and apparatus for sharing contents.

2. Description of the Related Art

Communication networks may provide video sharing services, allowing for sharing voice and video between users.

A conventional video sharing service uses an identifier for managing a video sharing session to enable sharing video content between a sender of the content using an electronic device and an opposite party who receives the content from the electronic device. The identifier is generated and managed by a server providing the video sharing service. An electronic device using the video sharing service receives the identifier from the server and utilizes the received identifier.

As per conventional video sharing services, in order to initiate a video sharing service, a user sends a request for initiating the service, and a server generates an identifier for managing the video sharing and transmits the identifier to a user so that the user may utilize the video sharing service. As a result, it takes considerable time to initiate a session for video sharing, rendering it difficult to use the video sharing service.

### SUMMARY

The present invention has been made to address at least the problems and disadvantages described above, and to provide at least the advantages described below.

Accordingly, an aspect of the present disclosure is to provide a video sharing method and an electronic device to generate a session identifier for a video sharing service with another electronic device without passing through an external electronic device and to perform a video sharing service using the generated session identifier.

Accordingly, another aspect of the present disclosure is to provide an electronic device which generates a session identifier for a video sharing service with another electronic device without passing through an external electronic device and performs a video sharing service using the generated session identifier, thereby reducing the time for initiating a video sharing session for the video sharing service.

In accordance with an aspect of the present disclosure, a first electronic device is provided. The first electronic device includes a communication interface, and a processor configured to obtain a request for running a content sharing service with a second electronic device, generate connection identification information using first user identification information corresponding to the first electronic device and second user identification information corresponding to the second electronic device, in response to the request, and transmit the connection identification information to a first external electronic device for providing the content sharing service between the first electronic device and the second electronic device, using the communication interface.

In accordance with another aspect of the present disclosure, a first electronic device is provided. The first electronic device includes a communication interface, and a processor configured to obtain a request for running a content sharing service with a second electronic device, identify first user identification information corresponding to the first electronic device and second user identification information corresponding to the second electronic device, in response to the request, and transmit the first user identification information and the second user identification information to a first external electronic device for providing the content sharing service between the first electronic device and the second electronic device, using the communication interface.

In accordance with another aspect of the present disclosure, a method for sharing a content is provided. The method includes obtaining, by a first electronic device, a request for running a content sharing service between the first electronic device and a second electronic device, generating connection identification information using first user identification information corresponding to the first electronic device and second user identification information corresponding to the second electronic device. in response to the request, and transmitting the generated connection identification information to a first external electronic device for providing the content sharing service between the first electronic device and the second electronic device.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1 is a block diagram of a configuration of an electronic device in a network environment, according to an embodiment of the present disclosure;

FIG. 2 is a block diagram of a configuration of an electronic device, according to an embodiment of the present disclosure;

FIG. 3 is a block diagram of a configuration of a program module, according to an embodiment of the present disclosure;

FIG. 4 is a block diagram of a system for a video sharing service in an electronic device, according to an embodiment of the present disclosure;

FIGS. 5A to 5C illustrate connection identification information, according to an embodiment of the present disclosure;

FIG. 6 is a flowchart of a method for operating a video sharing service, according to an embodiment of the present disclosure;

FIG. 7 is a signal flow diagram of a method for operating a video sharing service, according to an embodiment of the present disclosure;

FIGS. 8A and 8B illustrate methods for providing a video sharing service, according to an embodiment of the present disclosure;

FIG. 9 illustrates a method for providing a video sharing service, according to an embodiment of the present disclosure;

FIGS. 10A and 10B are signal flow diagrams of a method for operating a video sharing service, according to an embodiment of the present disclosure;

FIG. 11 is a flowchart of a method for operating a video sharing service, according to an embodiment of the present disclosure; and

FIG. 12 is a flowchart of a method for operating a video sharing service, according to an embodiment of the present disclosure.

### DETAILED DESCRIPTION OF EMBODIMENTS OF THE PRESENT DISCLOSURE

Hereinafter, embodiments of the present disclosure are described with reference to the accompanying drawings, in which like reference numerals are used to refer to like elements. However, it should be appreciated that the present disclosure is not limited to the disclosed embodiments, and all changes, equivalents, and/or replacements thereto also fall within to the scope of the present disclosure. Herein, the terms “have,” “may have,” “include,” or “may include” refer to the existence of a corresponding feature (e.g., a number, function, operation, or a component) and do not exclude the existence of other features.

The terms “A or B,” “at least one of A and/or B,” or “one or more of A and/or B” may include all possible combinations of A and B. For example, “A or B,” “at least one of A and B,” “at least one of A or B” may indicate all of (1) including A, (2) including B, or (3) including A and B.

The terms “first” and “second” may modify various components regardless of importance and/or order and are used to distinguish a component from another without limiting the components. For example, a first user device and a second user device may indicate different user devices regardless of the order or importance of the devices. For example, a first component may be referred to as a second component and vice versa, without departing from the scope of the present disclosure.

When an element (e.g., a first element) is referred to as being “coupled,” or “connected” with/to another element (e.g., a second element), the element can be coupled or connected with/to the other element directly or via a third element. In contrast, it will be understood that when an element (e.g., a first element) is referred to as being “directly coupled” or “directly connected” with/to another element (e.g., a second element), no other element (e.g., a third element) intervenes between the element and the other element.

The term “configured (or set) to” may be interchangeably used with the terms “suitable for,” “having the capacity to,” “designed to,” “adapted to,” “made to,” or “capable of” depending on circumstances. The term “configured (or set) to” does not necessarily mean “specifically designed in hardware to.” Rather, the term “configured to” may mean that a device can perform an operation together with another device or parts. For example, the term “processor configured (or set) to perform A, B, and C” may mean a generic-purpose processor (e.g., a central processing unit (CPU) or application processor) that may perform the operations by executing one or more software programs stored in a memory device or a dedicated processor (e.g., an embedded processor) for performing the operations.

The terms as used herein are provided merely to describe some embodiments thereof, but not to limit the scope of other embodiments of the present disclosure. It is to be understood that the singular forms may include plural forms as well unless the context clearly dictates otherwise. Unless defined otherwise, the terms used herein, including technical and scientific terms, have the same meaning as commonly understood by a person of ordinary skill in the art to which the present disclosure pertains. Further, terms such as those defined in commonly used dictionaries, should be interpreted as having meanings that are consistent with their meanings in the context of the relevant art and should not be interpreted as having idealized or overly formal meanings unless expressly so defined herein. In some cases, even terms defined herein should not be interpreted to exclude embodiments of the present disclosure.

An electronic device according to an embodiment of the present disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device. The wearable device may include at least one of an accessory-type device (e.g., a watch, a ring, a bracelet, an anklet, a necklace, glasses, contact lenses, or a head-mounted device (HMD)), a fabric or clothes-integrated device (e.g., electronic clothes), a body attaching-type device (e.g., a skin pad or tattoo), or a body implantable device (e.g., an implantable circuit).

An electronic device may also be a home appliance. The home appliance may include at least one of a television, a digital versatile disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame.

An electronic device may also be a medical device (e.g., diverse portable medical measuring devices, such as a blood sugar measuring device, a heartbeat measuring device, or a body temperature measuring device, a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, a sailing electronic device (e.g., a sailing navigation device or a gyro compass), an avionics device, a security device, a vehicular head unit, an industrial or home robot, an automatic teller machine (ATM), a point of sales (POS) device, or an Internet of Things (IoT) device (e.g., a light bulb, a sensor, an electric or gas meter, a sprinkler, a fire alarm, a thermostat, a street light, a toaster, fitness equipment, a hot water tank, a heater, or a boiler).

An electronic device may also be at least one of part of a piece of furniture or building/structure, an electronic board, an electronic signature receiving device, a projector, or a measurement device (e.g., a device for measuring water, electricity, gas, or electromagnetic waves).

An electronic device may be a flexible electronic device.

An electronic device may also be a combination of the above-listed devices.

However, an electronic device disclosed herein is not limited to the above-listed devices, and may include new electronic devices depending on the development of technology.

The term “user” may denote a human or another device (e.g., an artificial intelligence electronic device) using an electronic device.

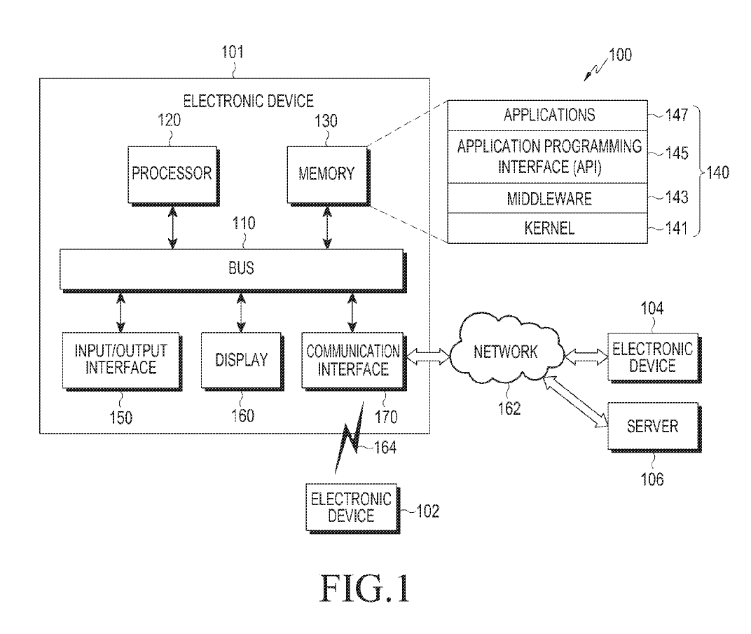

FIG. 1 is a block diagram of a configuration of an electronic device in a network environment, according to an embodiment of the present disclosure.

Referring to FIG. 1, an electronic device 101 in a network environment 100 is provided. The electronic device 101 includes a bus 110, a processor 120, a memory 130, an input/output interface 150, a display 160, and a communication interface 170. In some embodiments, the electronic device 101 may exclude at least one of the components or may add another component.

The bus 110 is a circuit for connecting the components with one another and transferring communications (e.g., control messages and/or data) between the components.

The processing module 120 includes one or more of a central processing unit (CPU), an application processor (AP), or a communication processor (CP). The processor 120 may perform control of at least one of the other components of the electronic device 101, and/or perform an operation or data processing relating to communication.

The memory 130 includes a volatile and/or non-volatile memory. For example, the memory 130 may store commands or data related to at least one other component of the electronic device 101. The memory 130 may store software and/or a program 140. The program 140 includes a kernel 141, middleware 143, an application programming interface (API) 145, and/or an applications 147. At least a portion of the kernel 141, middleware 143, or API 145 may be referred to as an operating system (OS).

The kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the applications 147 to access the individual components of the electronic device 101 to control or manage the system resources.

The middleware 143 may function as a relay to allow the API 145 or the applications 147 to communicate data with the kernel 141, for example.

Further, the middleware 143 may process one or more task requests received from the applications 147 in order of priority. For example, the middleware 143 may assign at least one of the applications 147 with a priority for using system resources (e.g., the bus 110, processor 120, or memory 130) of the electronic device 101. For example, the middleware 143 may perform scheduling or load balancing on the one or more task requests by processing the one or more task requests according to the priority assigned to at least one of the applications 147.

The API 145 is an interface allowing the applications 147 to control functions provided from the kernel 141 or the middleware 143. For example, the API 133 includes at least one interface or function (e.g., a command) for filing control, window control, image processing, or text control.

The input/output interface 150 may serve as an interface that may, e.g., transfer commands or data input from a user or other external devices to other components of the electronic device 101. Further, the input/output interface 150 may output commands or data received from other components of the electronic device 101 to the user or the other external device.

The display 160 includes a liquid crystal display (LCD), a light emitting diode (LED) display, an organic light emitting diode (OLED) display, a microelectromechanical systems (MEMS) display, or an electronic paper display. The display 160 may display various contents (e.g., text, images, videos, icons, or symbols) to the user. The display 160 includes a touchscreen and may receive a touch, gesture, proximity or hovering input using an electronic pen or a body portion of the user.

The communication interface 170 may set up communication between the electronic device 101 and a first electronic device 102, a second electronic device 104, or a server 106. For example, the communication interface 170 may be connected to the first external electronic device via short-range communication 164 and may be connected with the network 162 through wireless or wired communication to communicate with the second external electronic device 104.

The wireless communication may use at least one of, e.g., long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM), as a cellular communication protocol. Further, the wireless communication includes the short-range communication 164. The short-range communication 164 includes at least one of, e.g., Wi-Fi, bluetooth (BT), near-field communication (NFC), or GNSS. The GNSS includes at least one of, e.g., global positioning system (GPS), global navigation satellite system (Glonass), Beidou navigation satellite system (Beidou) or Galileo, the European global satellite-based navigation system. Hereinafter, the terms “GPS” and the “GNSS” may be interchangeably used.

The wired communication includes at least one of universal serial bus (USB), high definition multimedia interface (HDMI), recommended standard (RS)-232, or plain old telephone service (POTS).

The network 162 includes at least one of communication networks, e.g., a computer network (e.g., local area network (LAN) or wide area network (WAN)), Internet, or a telephone network.

The first and second external electronic devices 102 and 104 each may be a device of the same or a different type from the electronic device 101.

The server 106 may include a group of one or more servers.

All or some of operations executed on the electronic device 101 may be executed on another or multiple other electronic devices (e.g., the external electronic devices 102 and 104 or server 106). When the electronic device 101 should perform some function or service automatically or at a request, the electronic device 101, instead of or in addition to executing the function or service on its own, may request another device (e.g., external electronic devices 102 and 104 or server 106) to perform at least some of the functions or services. In this case, the other electronic device (e.g., external electronic devices 102 and 104 or server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used.

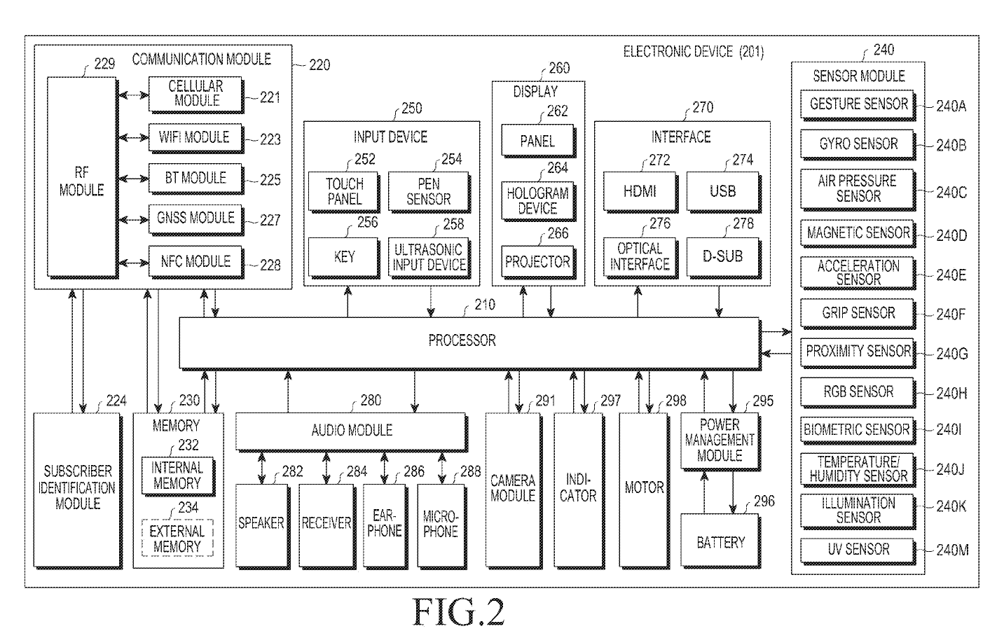

FIG. 2 is a block diagram of a configuration of an electronic device, according to an embodiment of the present disclosure.

Referring to FIG. 2, an electronic device 201 is provided. The electronic device 201 includes a processor (AP) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control multiple hardware and software components connected to the processor 210 by running an operating system or application programs, and the processor 210 may process and compute various data. The processor 210 may be implemented in a system on chip (SoC). The processor 210 may further include a graphic processing unit (GPU) and/or an image signal processor. The processor 210 may include at least some (e.g., the cellular module 221) of the components of the electronic device 201 shown in FIG. 2. The processor 210 may load a command or data received from at least one of other components (e.g., a non-volatile memory) into a volatile memory, process the command or data, and store various data in the non-volatile memory.

The communication module 220 includes a cellular module 221, a Wi-Fi module 223, a BT module 225, a GNSS module 227, a NFC module 228, and a radio frequency (RF) module 229.

The cellular module 221 may provide voice call, video call, text, or Internet services through a communication network. The cellular module 221 may perform identification or authentication on the electronic device 201 in the communication network using a subscriber identification module 224. The cellular module 221 may perform at least some of the functions providable by the processor 210. The cellular module 221 may include a communication processor (CP).

The Wi-Fi module 223, the BT module 225, the GNSS module 227, or the NFC module 228 may include a process for processing data communicated through the module. At least some of the cellular module 221, the Wi-Fi module 223, the BT module 225, the GNSS module 227, or the NFC module 228 may be included in a single integrated circuit (IC) or an IC package.

The RF module 229 may communicate communication signals (e.g., RF signals). The RF module 229 may include a transceiver, a power amp module (PAM), a frequency filter, a low noise amplifier (LNA), or an antenna. At least one of the cellular module 221, the Wi-Fi module 223, the BT module 225, the GNSS module 227, or the NFC module 228 may communicate RF signals through a separate RF module.

The subscription identification module 224 may include a card including a subscriber identification module and/or an embedded SIM and may contain unique identification information (e.g., an integrated circuit card identifier (ICCID) or subscriber information (e.g., an international mobile subscriber identity (IMSI)).

The memory 230 includes an internal memory 232 or an external memory 234. The internal memory 232 may include at least one of a volatile memory (e.g., a dynamic RAM (DRAM), a static RAM (SRAM), a synchronous dynamic RAM (SDRAM), etc.) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD).

The external memory 234 may include a flash drive, e.g., a compact flash (CF) memory, a secure digital (SD) memory, a micro-SD memory, a min-SD memory, an extreme digital (xD) memory, or a memory stick. The external memory 234 may be functionally and/or physically connected with the electronic device 201 via various interfaces.

The sensor module 240 may measure a physical quantity or detect a motion state of the electronic device 201. The sensor module 240 may convert the measured or detected information into an electrical signal. The sensor module 240 includes a gesture sensor 240A, a gyro sensor 240B, an air pressure sensor 240C, a magnetic sensor 240D, an acceleration sensor 240E, a grip sensor 240F, a proximity sensor 240G, a red-green-blue (RGB) sensor 240H, a biometric sensor 240I, a temperature/humidity sensor 240J, an illumination sensor 240K, and an Ultra Violet (UV) sensor 240M. Additionally or alternatively, the sensing module 240 may include an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 240 may further include a control circuit for controlling at least one or more of the sensors included in the sensing module 240. The electronic device 201 may further include a processor configured to control the sensor module 240 as part of an AP 210 or separately from the AP 210, and the electronic device 201 may control the sensor module 240 while the AP is in a sleep mode.

The input unit 250 includes a touch panel 252, a (digital) pen sensor 254, a key 256, and an ultrasonic input device 258.

The touch panel 252 may use at least one of capacitive, resistive, infrared, or ultrasonic methods. The touch panel 252 may further include a control circuit. The touch panel 252 may further include a tactile layer and may provide a user with a tactile reaction.

The (digital) pen sensor 254 may include a part of a touch panel or a separate sheet for recognition.

The key 256 may include a physical button, optical key or key pad.

The ultrasonic input device 258 may use an input tool that generates an ultrasonic signal and enable the electronic device 201 to identify data by sensing the ultrasonic signal through a microphone 288.

The display 260 includes a panel 262, a hologram device 264, and a projector 266.

The panel 262 may be implemented to be flexible, transparent, or wearable. The panel 262 may also be incorporated with the touch panel 252 in a module. The panel 262 may include a pressure sensor (or pose sensor) that may measure the strength of a pressure by the user's touch. The pressure sensor may be implemented in a single body with the touch panel 252 or may be implemented in one or more sensors separate from the touch panel 252.

The hologram device 264 may display three dimensional (3D) images (holograms) in the air by using light interference.

The projector 266 may display an image by projecting light onto a screen. The screen may be, for example, located inside or outside of the electronic device 201.

The display 260 may further include a control circuit to control the panel 262, the hologram device 264, or the projector 266.

The interface 270 includes a High Definition Multimedia Interface (HDMI) 272, a USB 274, an optical interface 276, or a D-subminiature (D-sub) 278. Additionally or alternatively, the interface 270 may include a mobile high-definition link (MHL) interface, a secure digital (SD) card/multimedia card (MMC) interface, or infrared data association (IrDA) standard interface.

The audio module 280 may convert a sound signal into an electrical signal and vice versa. The audio module 280 may process sound information input or output through e.g., a speaker 282, a receiver 284, an earphone 286, or the microphone 288.

The camera module 291 may be a device for capturing still images and videos, and may include one or more image sensors (e.g., front and back sensors), a lens, an image signal processor (ISP), or a flash such as an LED or xenon lamp.

The power manager module 295 may manage power of the electronic device 201. The power manager module 295 may include a power management integrated circuit (PMIC), a charger IC, or a battery gauge. The PMIC may have a wired and/or wireless recharging scheme. The wireless charging scheme may include a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power, a voltage, a current, or a temperature of the battery 296. The battery 296 may include a rechargeable battery or a solar battery.

The indicator 297 may indicate a particular state of the electronic device 201 or a part (e.g., the processor 210) of the electronic device 201, including e.g., a booting state, a message state, or recharging state.

The motor 298 may convert an electric signal to a mechanical vibration and may generate a vibrational or haptic effect.

A processing unit for supporting mobile TV, such as a GPU, may be included in the electronic device 201. The processing unit for supporting mobile TV may process media data conforming to a standard for digital multimedia broadcasting (DMB), digital video broadcasting (DVB), or mediaFlo™.

Each of the aforementioned components of the electronic device 201 may include one or more parts, and a name of the part may vary with a type of the electronic device 201. The electronic device 201 may include at least one of the aforementioned components, omit some of them, or include other additional component(s). Some of the components may be combined into an entity, and the entity may perform the same functions as the individual components do.

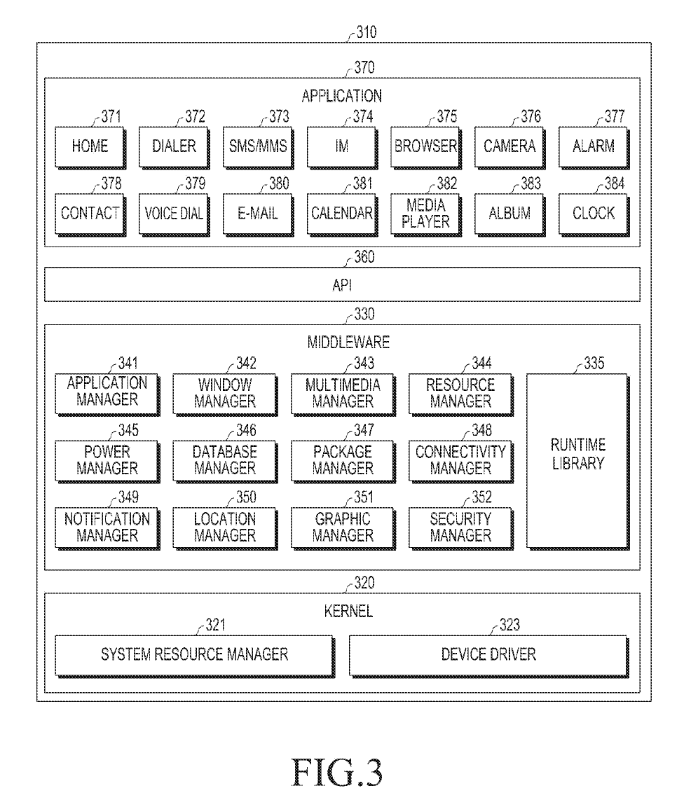

FIG. 3 is a block diagram of a configuration of a program module, according to an embodiment of the present disclosure.

Referring to FIG. 3, a program module 310 is provided. The program module 310 may include an operating system (OS) controlling resources related to the electronic device 101 and/or various applications 147 driven on the operating system. The operating system may include, e.g., Android™, iOS™, Windows™, Symbian™, Tizen™, or Samsung Bada OS™.

The program module 310 includes a kernel 320, middleware 330, an application programming interface (API) 360, and an application 370. At least a part of the program module 310 may be preloaded on the electronic device 101 or may be downloaded from an external electronic device (e.g., the external electronic devices 102 and 104) or a server (e.g., the server 106).

The kernel 320 may include a system resource manager 321 or a device driver 323.

The system resource manager 321 may perform control, allocation, or recovery of system resources. The system resource manager 321 may include a process managing unit, a memory managing unit, or a file system managing unit.

The device driver 323 may include a display driver, a camera driver, a Bluetooth driver, a shared memory driver, a USB driver, a keypad driver, a Wi-Fi driver, an audio driver, or an inter-process communication (IPC) driver.

The middleware 330 may provide various functions to the application 370 through the API 360 so that the application 370 may efficiently use limited system resources in the electronic device 101 or provide functions jointly required by the application 370. The middleware 330 includes a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module used by a compiler in order to add a new function through a programming language while the application 370 is being executed. The runtime library 335 may perform input/output management, memory management, or operation on arithmetic functions.

The application manager 341 may manage the life cycle of at least one application 370.

The window manager 342 may manage GUI resources used on a screen of the electronic device 101.

The multimedia manager 343 may recognize formats for playing various media files and use a codec appropriate for a format to perform encoding or decoding on media files.

The resource manager 344 may manage resources, such as source code of at least one application 370, memory or storage space.

The power manager 345 may operate together with a basic input/output system (BIOS) to manage battery or power and provide power information necessary for operating the electronic device 101.

The database manager 346 may generate, search, or vary a database to be used in at least one application 370.

The package manager 347 may manage installation or update of an application 370 that is distributed in the form of a package file.

The connectivity manager 348 may manage wireless connectivity, such as Wi-Fi or Bluetooth.

The notification manager 349 may display or notify an event, such as an incoming message, appointment, or proximity notification, of the user without interfering with the user.

The location manager 350 may manage locational information on the electronic device 101.

The graphic manager 351 may manage graphic effects to be offered to the user and a related user interface.

The security manager 352 may provide various security functions necessary for system security or user authentication.

When the electronic device 101 has telephony capability, the middleware 330 may further include a telephony manager for managing voice call or video call functions of the electronic device 101.

The middleware 330 may include a middleware module forming a combination of various functions of the above-described components. The middleware 330 may provide a specified module for each type of operating system in order to provide a differentiated function. Further, the middleware 330 may dynamically omit some existing components or add new components.

The API 360 (e.g., the API 145) may be a set of API programming functions and may have different configurations depending on operating systems. For example, in the case of Android™ or iOS™, one API set may be provided per platform, and in the case of Tizen™, two or more API sets may be offered per platform.

The application 370 includes one or more applications that may provide functions of a home 371, a dialer 372, a short message service (SMS)/multimedia messaging service (MMS) 373, an instant message (IM) 374, a browser 375, a camera 376, an alarm 377, a contact 378, a voice dial 379, an email 380, a calendar 381, a media player 382, an album 383, and a clock 384. The application 370 may additionally or alternatively include an application which provides a health-care function (e.g., measuring the degree of workout or blood sugar), or environmental information (e.g., air pressure, moisture, or temperature information).

The application 370 may include an information exchanging application supporting information exchange between the electronic device 101 and an external electronic device. Examples of the information exchange application may include, but is not limited to, a notification relay application for transferring specific information to the external electronic device, or a device management application for managing the external electronic device.

The notification relay application may include a function for relaying notification information generated from an application 370 of the electronic device 101 (e.g., the SMS/MMS application, email application, health-care application, or environmental information application) to the external electronic device (e.g., the external electronic devices 102 and 104). Further, the notification relay application may receive notification information from the external electronic device and may provide the received notification information to the user.

The device management application may perform at least some functions of the external electronic device (e.g., the external electronic device 102 or 104) communicating with the electronic device 101 (for example, turning on/off the external electronic device (or some components of the external electronic device) or controlling the brightness or resolution of the display), and the device management application may manage (e.g., install, delete, or update) an application operating in the external electronic device or a service (e.g., call service or message service) provided from the external electronic device.

The application 370 may include an application (e.g., a health-care application of a mobile medical device) designated according to an attribute of the external electronic device (e.g., the external electronic devices 102 and 104). The application 370 may include an application received from the external electronic device (e.g., the server 106 or external electronic devices 102 and 104). The application 370 may include a preloaded application or a third-party application downloadable from the server 106. The names of the components of the program module 310 may be varied depending on the type of operating system.

At least a part of the program module 310 may be implemented in software, firmware, hardware, or in a combination of two or more thereof. At least a part of the program module 310 may be implemented (e.g., executed) by e.g., the processor 120. At least a part of the program module 310 may include a module, program, routine, set of instructions, process, or the like for performing one or more functions.

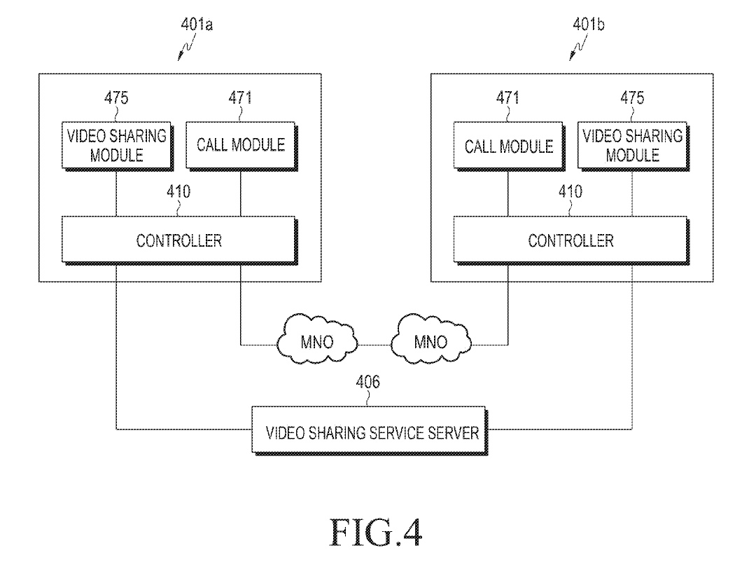

FIG. 4 is a block diagram of a system for a video sharing service in an electronic device, according to an embodiment of the present disclosure.

Referring to FIG. 4, a system for a video sharing service includes a first electronic device 401a, a second electronic device 401b, and a video sharing service server 406.

The first electronic device 401a and the second electronic device 401b may be an electronic device as illustrated in FIG. 1. The first electronic device 401a and the second electronic device 401b each include a controller 410, a call module 471, and a video sharing module 475. Further, the first electronic device 401a and the second electronic device 401b may be the same or similar electronic devices, e.g., smailphones, smart pads, tablet PCs, laptop computers, or other electronic devices providing multimedia service functionality as well as voice call services. The controller 410 may include one or more of a central processing unit (CPU), an application processor (AP), or a communication processor (CP). The controller 410 may process at least part of information obtained from the other elements (e.g., the call module 471 or video sharing module 475) of the first electronic device 401a or second electronic 401b and may provide the same to the user in various manners. The controller 410 may control all of the components of the first electronic device 401a or second electronic 401b.

The controller 410 may perform a voice call through a mobile network operator (MNO). Here, the MNO refers to a communication network operated by a communication service provider. The controller 410 may run the call module 471 to perform a voice call. The call module 471 refers to a default voice call application embedded in the first electronic device 401a or second electronic 401b. The call module 471 may include a voice call application supportive of a 3G network circuit switch (CS) call or a 4G network packet switch (PS) call. Further, the call module may include a voice call application (e.g., VoLTE) utilizing an IP multimedia subsystem (IMS) of a service provider's network. The call module 471 may include an over-the-top (OTT)-based voice call application that does not utilize the service provider's MNO. Further, the call module 471 may include an application (e.g., Facetime™ or Skype™) for a voice call service provided by a third party.

The controller 410 may run the call module 471 to send a voice call. Here, the controller 410 may display an execution screen of the call module 471 on the display 160. A keypad may be displayed on the execution screen of the call module 471. Here, the display may be formed of a touchscreen. The controller 410 may detect a touch on the touchscreen and receive an input. Accordingly, the controller 410 may detect a touch on the keypad on the touchscreen to receive a phone number of a recipient to whom a voice call is to be connected. The controller 410 may extract a contact name corresponding to the inputted phone number from the memory 130 and display the contact name. The memory 130 may include a database containing the contact name and the phone number. A voice call icon may be displayed on the execution screen of the call module 471. A selection of the voice call icon may be received to send a voice call.

The controller 410 may use a video sharing service enabling video sharing while the voice call is running. For example, the controller 410 may run the video sharing module 475.

The video sharing module 475 may include a video sharing application enabling a video sharing between users without utilizing the service provider's network. The video sharing module 475 may mean a video sharing application that is connected via communication with the video sharing service server 406 to support the video sharing service. The video sharing module 475 may include an OTT-based video sharing application that utilizes a mobile network without using the service provider's network.

The controller 410 may run the video sharing module 475 to provide a video sharing service enabling video sharing while the voice call is in progress. Here, when the voice call is in progress and the call module 471 runs, the controller 410 may also run the video sharing module 457 and may keep the video sharing module 476 in a standby state until a request is made from the user. The controller 410 may determine whether a video sharing service is available while the voice call using the call module 471 is in progress. Such determination may be performed by the video sharing module 475 or through the OS's function or another application installed on the first electronic device 401a or second electronic 401b. Further, the controller 410 may determine whether a video sharing service is available at the time of establishing a voice call or periodically while the voice call is connected. Alternatively, such determination may be triggered and performed by an event (e.g., the user's gesture). For example, upon detecting a user gesture indicating that the user views the display 160 while the voice call is in progress using the call module 471, the controller 410 may display the execution screen of the video sharing module 475 on the display 160. Here, the execution screen of the video sharing module 475 may be part of an execution screen of the voice call or may be an execution screen of the video sharing service into which the execution screen of the voice call switches. Further, when a video sharing button is displayed on the execution screen of the voice call displayed on the display 160 while the voice call using the call module 471 is in progress, the controller 410 may detect a touch on the button and display the execution screen of the video sharing module 475 on the display 160. The controller 410 may receive an input for a video sharing from the user through the execution screen of a video sharing service displayed on the display 160 and provide the video sharing service according to the user's input.

The controller 410 may relay the exchange of relevant information for a video sharing service between the call module 471 and the video sharing module 475. For example, the controller 410 may provide a comprehensive call history managing function of the call module 471 to the video sharing module 475. Further, the call module 471 may identify a video sharing history through the video sharing module 475 or, alternatively, the video sharing module 475 may identify a video sharing history through the call module 471.

The controller 410 may simultaneously provide a video sharing service through the video sharing module 475 and a voice call through the call module 471. For example, the controller 410 may communicate voice data through the call module 471 and video sharing data through the video sharing module 475. Further, the controller 410 may communicate voice and video data through the video sharing module 475. In this case, the controller 410 may stop transmission and reception of voice data while maintaining the voice call connection of the call module 471. For example, the controller 410 may maintain transmission and reception of virtual data to prevent the voice call connection of the call module 471. Further, the controller 410 may notify the service provider's server, which relays the voice call of the call module 471 through the video sharing module 475, that the video sharing service is in progress, thereby requesting that the voice call remain connected. In such case, when the video sharing service terminates, the video sharing module 475 may notify the service provider's server of the termination of the video sharing service so that voice call connection may be performed again.

The video sharing service server 406 may play a role as a relay server that establishes a communication connection with the first electronic device 401a or second electronic 401b and provides a support for establishing a communication connection with the video sharing module 475 under the control of the controller 410 of the first electronic device 401a or second electronic 401b so that a video sharing service may be provided between the first electronic device 401a and the second electronic device 401b. The video sharing service server 406 may initially provide a DNS function alone for establishing a communication connection between the first electronic device 401a and the second electronic device 401b and then provide a support for establishing a peer-to-peer (P2P) connection by the video sharing modules 475 of the first electronic device 401a and the second electronic device 401b.

The video sharing service server 406 may support a function of a push server for establishing a communication connection between the first electronic device 401a and the second electronic device 401b. The push server may be implemented as a server separate from the video sharing service server 406.

The video sharing service server 406 may provide functions, such as video data encoding and decoding, codec conversion, or frame rate adjustment so that a multimedia function may be provided in the information searching system.

The first electronic device 401a or second electronic 401b may include the memory 130 storing one or more pieces of user identification information, the communication interface 170, and a controller 410.

The controller 410 may obtain a request for running a video sharing service between the first electronic device 401a and the second electronic device 401b. Here, upon detecting the user gesture indicating that the user views the screen while the voice call is in progress using at least one sensor of the sensor module 240 included in the first electronic device 401a or second electronic 401b, the controller 410 may obtain the gesture as a request for running the video sharing service. Further, upon detecting an input of the user touching the video sharing button displayed on the display 160 while the voice call is in progress, the controller 410 may obtain the touch input as a request for running the video sharing service

The controller 410 may generate connection identification information using first user identification information corresponding to the first electronic device 401a and second user identification information corresponding to the second electronic device 401b in response to the request. The first user identification information and the second user identification information, respectively, may be the respective phone numbers of the first electronic device 401a and the second electronic device 401b. The first user identification information and the second user identification information, respectively, may be the respective unique device information (e.g., MAC addresses or serial numbers) of the first electronic device 401a and the second electronic device 401b.

The controller 410 may transmit the connection identification information to the video sharing service server 406 for providing a video sharing service between the first electronic device 401a and the second electronic device 401b using the communication interface 170.

The connection identification information generated by the controller 410 may be generated by the video sharing module 475 installed in the first electronic device 401a or second electronic 401b. The connection identification information may be configured as a function which outputs an outcome using at least one or more factors, for example.

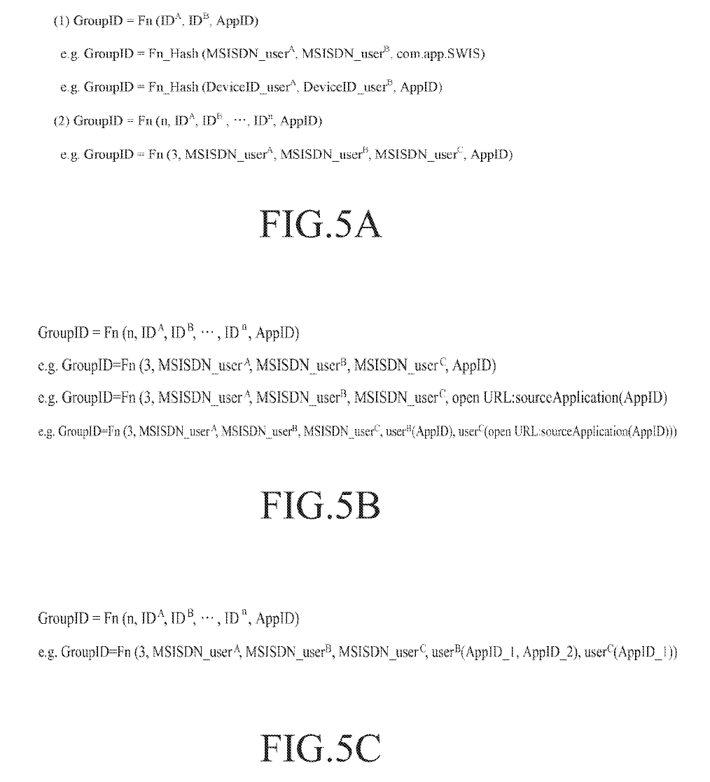

FIGS. 5A to 5C illustrate connection identification information, according to an embodiment of the present disclosure.

Referring to FIG. 5A, the connection identification information may be defined as shown. As shown in (1) of FIG. 5A, the connection information (i.e., Group ID) may be implemented in such a manner that the connection identification information is outputted from inputs, ID^{A}, ID^{B}, and AppID.

For example, connection identification information, as an outcome, may be outputted through a Hash function receiving MSISDN_user^{A}, MSISDN_user^{B}, and com.app.SWIS, as inputs. For example, the MSISDN may be a phone number. Alternatively, a DevicelD may be utilized. For example, the DevicelD may be a MAC address or serial number of the electronic device.

As shown in (2) of FIG. 5A, there may be a plurality of input factors, and a factor regarding the number of users may be included in the input factors. For example, 3 users, MSISDN_user^{A}, MSISDN_user^{B}, MSISDN_user^{C}, and com.app.SWIS may be received as inputs, and connection identification information may be outputted as an outcome. Additionally, values other than the factors shown in FIG. 5A may be inputted. For example, a dynamic value or temporal value may be added to generate certain random connection identification information.

The connection identification information may be utilized to differentiate video sharing connections between the first and second electronic devices 401a and 401b so as to provide a video sharing service. In other words, the connection identification information may function to distinguish among a plurality of possible video sharing connections. That is, the video sharing service server 406 may differentiate and manage a plurality of video sharing connections through the connection identification information. Further, since the connection identification information is an outcome obtained by using, as inputs, factors capable of identifying users or electronic devices, users or electronic devices that may participate in a video sharing connection may be authenticated using the connection identification information. For example, when receiving a request for joining a video sharing service from user C while a video sharing is in progress between users A and B, the video sharing service server 406 may determine whether to allow user C to join the video sharing service utilizing connection identification information that is generated using information regarding users A and B and is in use, and information regarding user C that is received from user C. Further, when user A is disconnected due to, for example, a deterioration of communication channel environment, a change in the communication network, or a variation in the settings of the first electronic device 401a or second electronic device 401b while users A and B share the video sharing, user A may attempt to reconnect. In this case, the video sharing service server 406 may permit the reconnection to the video sharing service utilizing the existing connection identification information and information regarding user A that is received from user A.

The connection identification information generated by the controller 410 may be generated by the video sharing module 475 installed in the first electronic device 401a or second electronic 401b. Further, the generated connection identification information may be varied according to a variation in the environment where the video sharing service is provided.

Referring to FIG. 5B, the variation in the connection identification information may be determined as shown. As shown in FIG. 5B, the connection identification information may contain identification information (i.e., AppID) regarding the application for providing the video sharing service. The application identification information may be obtained using the operating system (OS) information of the first electronic device 401a or second electronic 401b. For example, an OS-specific command corresponding to the application identification information may be generated as the AppID. For example, when receiving the AppID (e.g., openURI or sourceApplication(AppID)) added with the OS-specific command, the video sharing service server 406 may determine the type of notification (e.g., push) that is to be transferred to the opposite party's electronic device according to the OS-specific command.

Upon performing a multilateral video sharing service, each piece of application identification information may be generated or varied, and user identification information (i.e., user^{A}, MSISDN_user^{A}) corresponding to the generated or varied application identification information may be added.

Additionally, the video sharing service server 406 may create the received user identification information and connection identification information, and store such information in a database. The user identification information and connection identification information that has been stored in the database may be used in a video sharing service that is to be provided later. Further, the video sharing service server 406 may use the database for multimedia functions (e.g., encoding and decoding, codec conversion, or frame rate adjustment). For example, the video sharing service server 406 may adjust a provided codec or frame rate based on whether users of the video sharing service use the same OS. The connection identification information generated by the controller 410 may be generated by the video sharing module 475 installed in the first electronic device 401a or second electronic 401b. Further, the generated connection identification information may be varied to be performed by multiple video sharing applications depending on the environment where the video sharing service is provided.

Referring to FIG. 5C, the variation in the connection identification information may be determined as shown. For example, the application identifier may be varied so that the connection identification information may be performed by a plurality of video sharing applications.

Such connection identification information enables use of a multilateral video sharing service and a plurality of video sharing applications. For example, user^{B} may have a plurality of video sharing applications installed, each of which may be an electronic device different from the others. AppID_1 may be included in a portable electronic device, and AppID_2 may be included in a stationary electronic device (e.g., a TV). The portable electronic device may receive connection identification information, as shown in FIG. 5C, from the video sharing service server 406 and may run a video sharing application corresponding to the application identifier AppID_1. The portable electronic device may transfer the application identifier AppID_2 to the stationary electronic device. Further, the video sharing service server 406 may transfer it to the portable electronic device and the stationary electronic device based on the connection identification information and user identification information established in the database.

The controller 410 may transmit the connection identification information, as at least part of an initialize message for setting up a communication connection between the first electronic device 401a and the video sharing service server 406, to the video sharing service server 406.

The controller 410 may simultaneously transmit the connection identification information, as at least part of an invite message, to a push server that is established separately from the video sharing service server 406. The push server may function to transmit the invite message received from the first electronic device 401a to the second electronic device 401b. Further, the push server may be configured as a single body in the video sharing service server 406.

The controller 410 may generate the connection identification information using the application identification information corresponding to the application for running the video sharing service.

The controller 410 may identify an first external electronic device 102, such as a TV, positioned near the first electronic device 401a using a short-range communication interface, and transmit a video content by the video sharing service to the first external electronic device 102 so that the video content may be provided through the first external electronic device 102.

The controller 410 may obtain identification information corresponding to the first external electronic device 102 and modify the connection identification information based on the identification information.

The controller 410 may run the video sharing service while the first electronic device 401a and the second electronic device 401b are in a voice communication connection. The voice communication may be run through a first application (e.g., the call module 471), and the video sharing service may be run through a second application (e.g., the video sharing module 475).

According to an embodiment of the present disclosure, an electronic device comprises a memory for storing at least one or more pieces of user identification information, a communication interface, and a processor configured to obtain a request for running a content sharing service with a first external electronic device, generate connection identification information using first user identification information corresponding to the electronic device and second user identification information corresponding to the first external electronic device in response to the request, and transmit the connection identification information to a second external electronic device for providing the content sharing service between the electronic device and the first external electronic device using the communication interface.

The processor may be configured to transmit the connection identification information, as at least a portion of an initialize message for establishing a communication connection between the electronic device and the second external electronic device, to the second external electronic device.

The processor may be configured to simultaneously transmit the connection identification information, as at least a portion of an invite message, to a third external electronic device. The invite message may be configured to be transmitted to the first external electronic device through the third external electronic device.

The processor may be configured to generate the connection identification information using application identification information corresponding to an application for running the content sharing service.

The electronic device may further comprise a short-range communication interface, wherein the processor may be configured to identify a third external electronic device positioned near the electronic device using the short-range communication interface and transmit a content to the third external electronic device so that the content may be provided by the content sharing service through the third external electronic device.

The processor may be configured to obtain third user identification information corresponding to the third external electronic device and modify the connection identification information based on the third user identification information.

The processor may be configured to run the content sharing service while the electronic device and the first external electronic device are in a voice call connection.

The processor may be configured to run a voice call through a first application and run the content sharing service through a second application.

According to an embodiment of the present disclosure, an electronic device comprises a memory for storing at least one or more pieces of user identification information, a communication interface, and a processor configured to obtain a request for running a content sharing service with a first external electronic device, identify first user identification information corresponding to the electronic device and second user identification information corresponding to the first external electronic device in response to the request, and transmit the first user identification information and the second user identification information to a second external electronic device for providing the content sharing service between the electronic device and the first external electronic device using the communication interface.

The processor may be configured to transmit the first user identification information and the second user identification information, as at least a portion of an initialize message for establishing a communication connection between the electronic device and the second external electronic device, to the second external electronic device.

The processor may be configured to simultaneously transmit the first user identification information and the second user identification information, as at least a portion of an invite message, to a third external electronic device. The invite message may be configured to be transmitted to the first external electronic device through the third external electronic device.

The processor may be configured to transmit application identification information corresponding to an application for running the content sharing service, along with the first user identification information and the second user identification information, to the second external electronic device.

The electronic device may further comprise a short-range communication interface, wherein the processor may be configured to identify a third external electronic device positioned near the electronic device using the short-range communication interface and transmit a content to the third external electronic device so that the content may be provided by the content sharing service through the third external electronic device.

The processor may be configured to obtain third user identification information corresponding to the third external electronic device and transmit the third user identification information, along with the first user identification information and the second user identification information, to the second external electronic device.

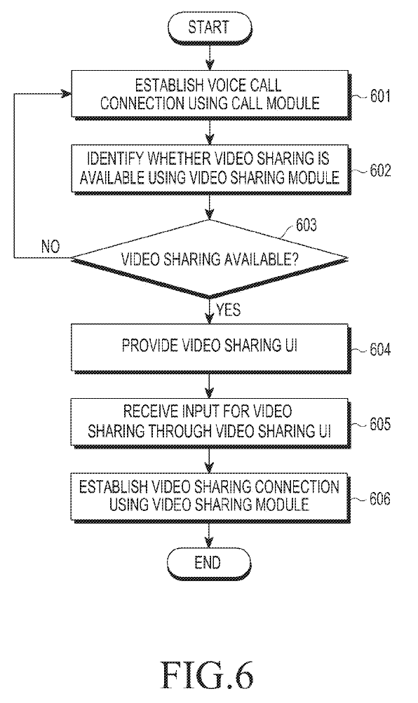

FIG. 6 is a flowchart of a method for operating a video sharing service, according to an embodiment of the present disclosure.

Referring to FIG. 6, at step 601, the first electronic device 401a may establish a voice call connection with the second electronic device 401b using the call module 471 (e.g., a voice call application). Here, the voice call refers to a basic phone call using a communication network operated by a service provider.

At step 602, the first electronic device 401a may determine whether video sharing with the second electronic device 401b is available using the video sharing module 475 (e.g., a video sharing application). The determination of whether the video sharing is available may be performed through the video sharing application or through another application installed on the first electronic device 401a or through a function of the operating system (OS). Further, the determination of whether a video sharing service is available may be performed at the time of establishing a voice call or periodically while the voice call is connected. Alternatively, such determination may be triggered and performed by an event (e.g., a user's gesture).

At step 603, when video sharing is not available, the first electronic device 401a may return to step 601 to maintain the voice call connection using the voice call application. In contrast, at step 603, when video sharing is available, the first electronic device 401a may proceed to step 604 and display an execution screen of the video sharing application. Here, the execution screen of the video sharing application may be part of an execution screen of the voice call application or may be an execution screen of the video sharing application into which the execution screen of the voice call switches.

At step 605, the first electronic device 401a may receive an input for a video sharing through the execution screen of the video sharing application.

At step 606, the first electronic device 401a may perform a communication connection for a video sharing service with the second electronic device 401b using the video sharing application. Here, the video sharing service may be provided simultaneously with the voice call. Further, the video sharing service may communicate a voice and data through a single path. In this case, the first electronic device 401a may stop the transmission and reception of only voice data while maintaining the call connection of the voice call application. To that end, the voice call application may maintain transmission and reception of virtual data to prevent the voice call connection from releasing. Further, the video sharing application notify the service provider's server, which relays the voice call, that the video sharing service is in progress, thereby requesting that the voice call remain connected. In such case, when the video sharing service terminates, the video sharing application may notify the service provider's server of the termination of the video sharing service so that voice call connection may be performed again.

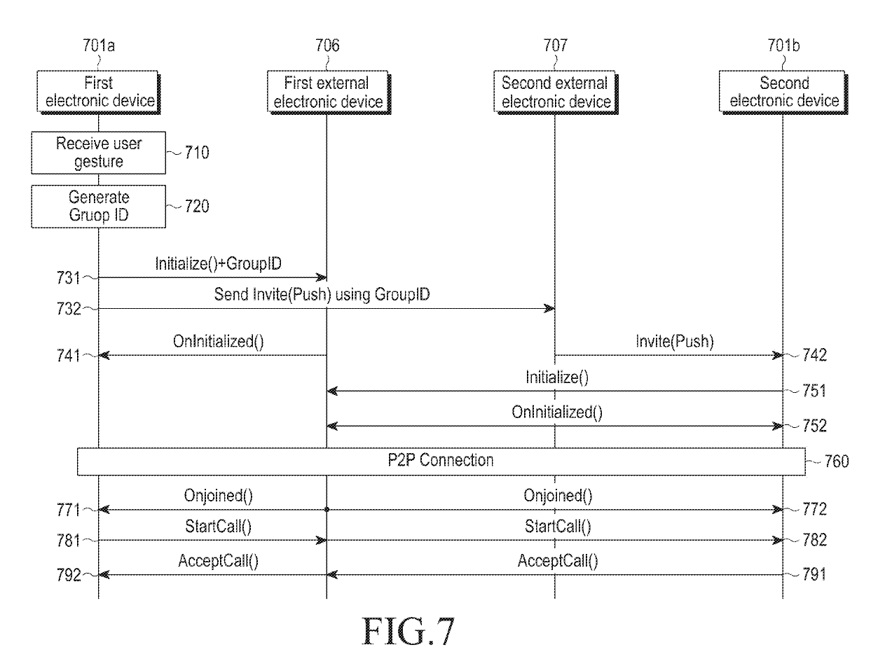

FIG. 7 is a signal flow diagram of a method for operating a video sharing service, according to an embodiment of the present disclosure.

Referring to FIG. 7, at step 710, a first electronic device 701a, upon detecting a gesture indicating that the user views the screen while a voice call, using a voice call application, is in progress, may obtain the gesture as a request for running a video sharing service. Alternatively, upon detecting an input of the user touching on a video sharing button displayed on a voice call execution screen while the voice call is in progress, the first electronic device 701a may obtain the touch input as a request for running the video sharing service

At step 720, the first electronic device 701a may generate connection identification information (e.g., GroupID) for managing a video sharing connection so that a video sharing service may be provided between the first electronic device 701a and a second electronic device 701b of an opposite party of the voice call using the voice call application. The first electronic device 701a may generate the connection identification information using first user identification information corresponding to the first electronic device 701a and second user identification information corresponding to the second electronic device 701b. The first user identification information and the second user identification information, may be the respective phone numbers of the first electronic device 701a and the second electronic device 701b. The first user identification information and the second user identification information may be the respective unique device information (e.g., MAC addresses or serial numbers) of the first electronic device 701a and the second electronic device 701b. Further, the video sharing application may obtain the first and second user identification information by exchanging information with the voice call application. Alternatively, the identification information may be obtained through another application installed on the first electronic device 701a or through a function of the OS.

At step 731, the first electronic device 701a may transmit, to a first external electronic device 706 (e.g., the video sharing service server 406), an Initialize message, including the connection identification information, to initiate a video sharing service.

At step 732, the first electronic device 701a may transmit, to a second external electronic device 707 (e.g., a push server), an Invite message, including the connection identification information, to invite a second electronic device 701b to attend the video sharing service.

Steps 731 and 732 may be performed simultaneously and in parallel to reduce the time required to initiate the video sharing service.

At step 741, the first external electronic device 706 may transmit, to the first electronic device 701a, an OnInitialized message accepting a video sharing connection for providing the video sharing service.

At step 742, the second external electronic device 707 may transmit, to the second electronic device 701b by push, the Invite message received from the first electronic device 701a.

At step 751, the second electronic device 701b may transmit, to the first external electronic device 706, an Initialize message, corresponding to the received invite message, for initializing the video sharing service.

At step 752, the first external electronic device 706 may transmit, to the second electronic device 701b, an OnInitialized message for accepting a video sharing connection to provide a video sharing service.

At step 760, the first electronic device 701a and the second electronic device 701b may establish the video sharing connection for the video sharing service. Here, the video sharing connection may be a P2P connection that is directly made between the first electronic device 701a and the second electronic device 701b.

At steps 771 and 772, the first external electronic device 706 may transmit, to the first electronic device 701a and the second electronic device 701b, an OnJoined message including a result of joining the video sharing service.

At steps 781 and 782, the first electronic device 701a may transmit, to the second electronic device 701b, via the first external electronic device 706, a StartCall message requesting to initiate the video sharing service.

At steps 791 and 792, the second electronic device 701a may transmit, to the first electronic device 701a, via the first external electronic device 706 an AcceptCall message accepting the request to initiate the video sharing service.

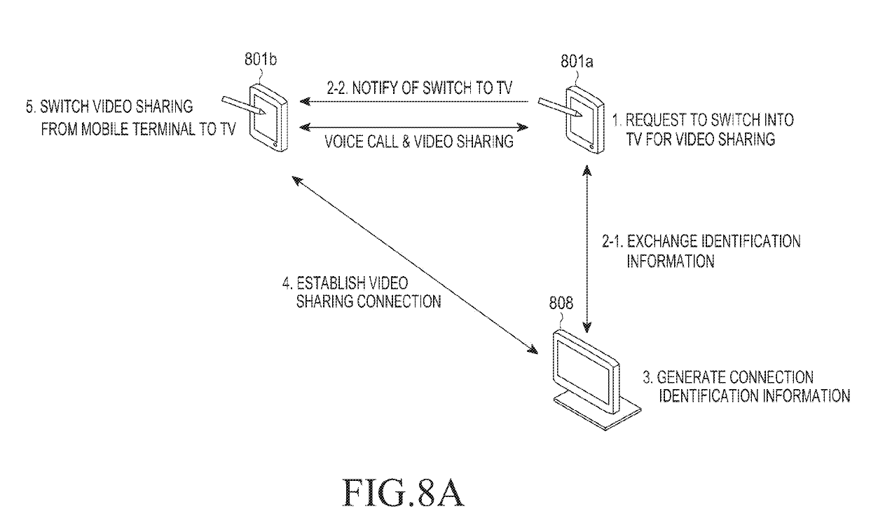

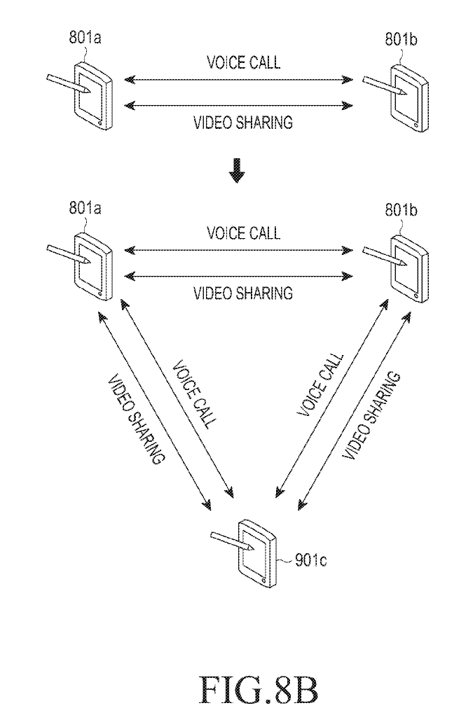

FIGS. 8A and 8B illustrate methods for providing a video sharing service, according to an embodiment of the present disclosure.

Referring to FIG. 8A, a method for providing a video sharing service between two electronic devices is provided.

As shown in FIG. 8A, the user may desire to share a TV 808 for video while using a first mobile terminal 801a for a voice call.

As shown in step 1, the first mobile terminal 801a may request to switch video sharing to the TV 801 that is positioned nearby. To that end, the first mobile terminal 801a may establish a short-range communication connection with a TV 808 using a short-range communication interface, such as a Wi-Fi module, BT module, or NFC module.

As shown in step 2-1, the first mobile terminal 801a and the TV 808 may mutually exchange identification information through the short-range communication connection).

As shown in step 2-2, the first mobile terminal 801a may notify a second mobile terminal 801b of switching the video sharing to the TV.

As shown step 3, the TV 808 may receive connection identification information for a video sharing service through exchange of information with the first mobile terminal 801a and enable its identification information to be included in the connection identification information, thereby modifying the connection identification information. In this case, the connection identification information may be modified by the first mobile terminal 801a.

As shown in step 4, the TV 808 may exchange the modified connection identification information with the first mobile terminal 801a and the second mobile terminal 801b and establish the video sharing connection with the second mobile terminal 801b.

As shown in step 5, the second mobile terminal 801b may switch from the first mobile terminal 801a to the TV 808 for video sharing.

Referring to FIG. 8B, a method for providing a video sharing service between more than two electronic devices is provided.

As shown in FIG. 8B, while user A 801a and user B 801b use a voice call and video sharing service, another user C 801c may join and a 3-way call or group call may be performed. When user A 801a, user B 801b, and user C 801c all happen to share the video, user A 801a and user B 801b may need to modify the connection identification information for the video sharing service. For example, since the connection identification information used for a connection between user A 801a and user B 801b is information generated using user identification information (e.g., phone number, MAC address, or serial number) regarding user A 801a and user B 801b, user C 801c may not join the video sharing service. Hence, under the 3-way call or group call circumstance, the connection identification information may be modified using the user identification information for all the users in the manner shown in (2) of FIG. 5A. Then, a video sharing connection among user A 801a, user B 801b, and user C 801c may be performed using the modified connection identification information. When this process is complete, user A 801a may transmit video through a video sharing connection newly established. In other words, the connection identification information for video sharing is updated in the position of user A 801a and user B 801b, and connection identification information for a new video sharing is obtained in the position of user C 801c.

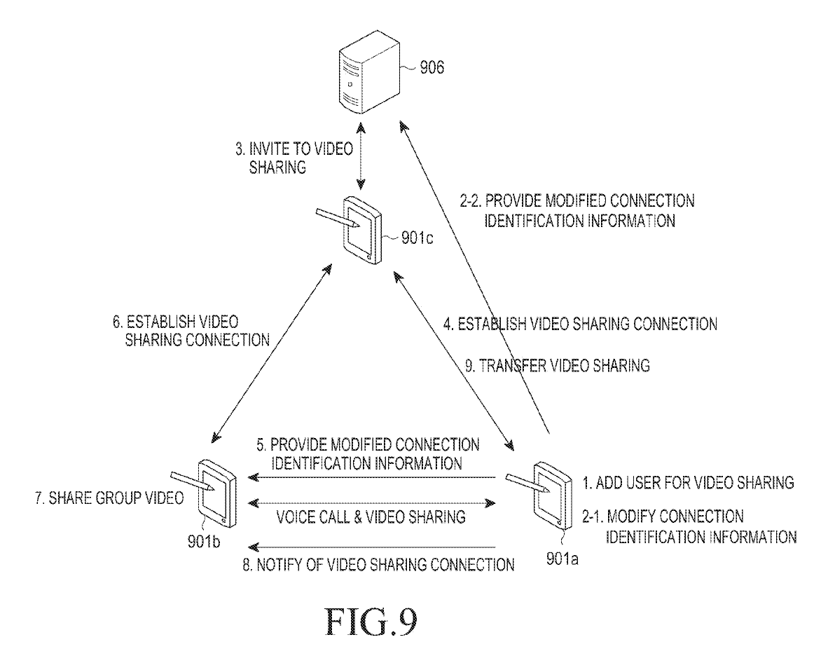

FIG. 9 illustrates a method for providing a video sharing service, according to an embodiment of the present disclosure.

Referring to FIG. 9, a method for providing a video sharing service between more than two electronic devices is provided.

As shown in FIG. 9, while a first mobile terminal 901a and a second mobile terminal 901b use a voice call and video sharing, a new user, a third mobile terminal 901c, may be added to form a multilateral call connection.

At step 1, the first mobile terminal 901a may request to add a new user to the video sharing service.

At step 2-1, the first mobile terminal 901a may modify existing connection identification information for a user who is to be newly added.

At step 2-1, the first mobile terminal 901a may provide the video sharing service server 906 with the modified connection identification information.

At step 3, the video sharing service server 906 may transmit an invite message containing the modified connection identification information to the third mobile terminal 901c that is to be newly added.

At step 4, the third mobile terminal 901c may establish a video sharing connection with the first mobile terminal 901a using the modified connection identification information.

At step 5, the first mobile terminal 901a may provide the modified connection identification information to the second mobile terminal 901b.

At step 6, the second mobile terminal 901b and the third mobile terminal 901c may establish a video sharing connection using the modified connection identification information.

At step 7, the second mobile terminal 901b may establish a multilateral video sharing connection with the first mobile terminal 901a and the third mobile terminal 901c.

At step 8, the first mobile terminal 901a may notify the second mobile terminal 901b of the termination of the multilateral video sharing connection.

The first mobile terminal 901a may transfer the video sharing to the third mobile terminal 901c that has the video sharing connection newly formed.

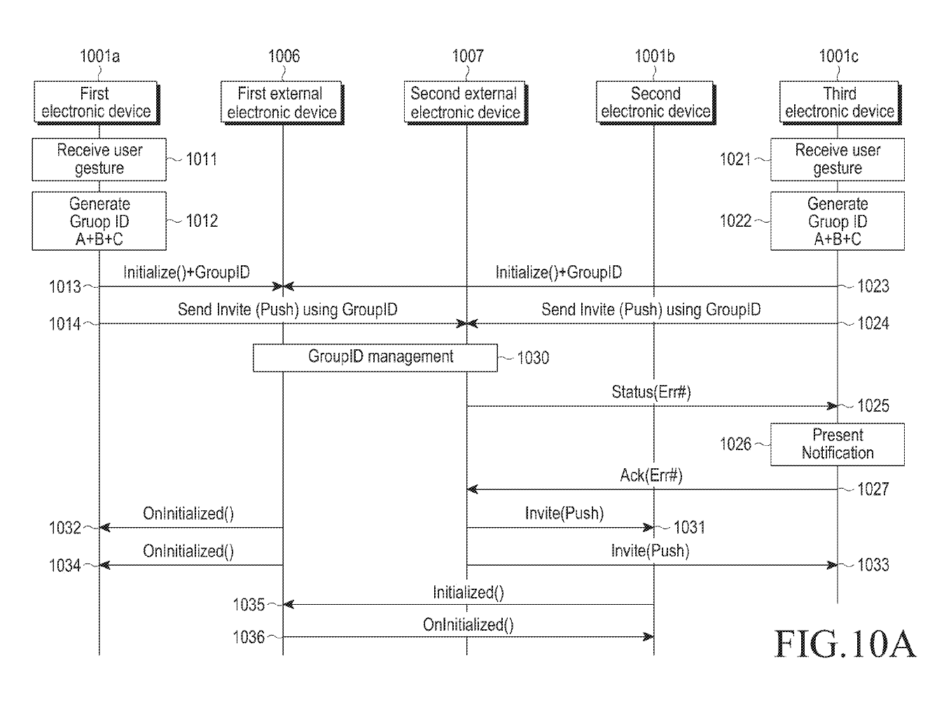

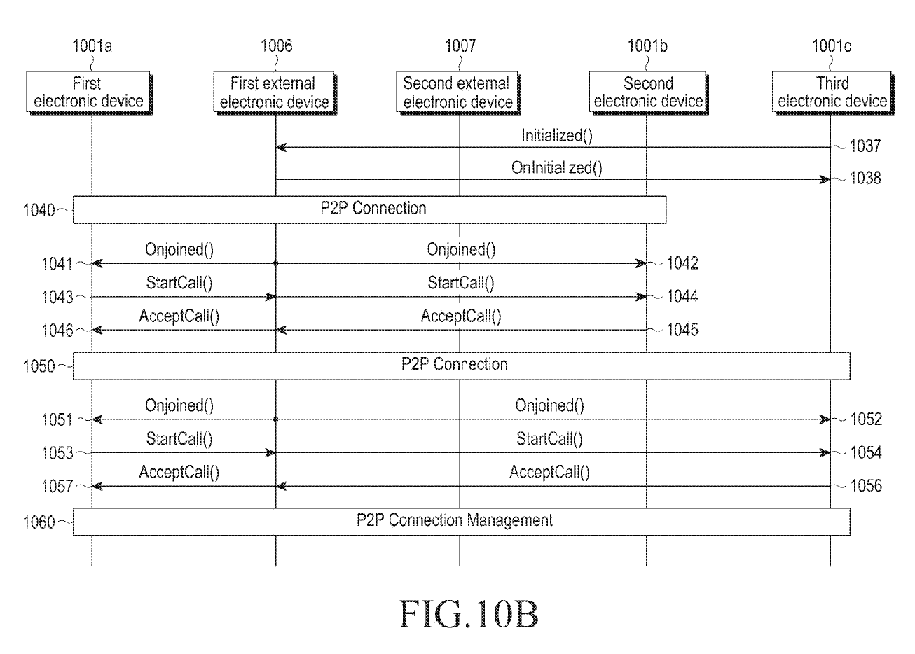

FIGS. 10A and 10B are signal flow diagrams of a method for operating a video sharing service, according to an embodiment of the present disclosure.

Referring to FIGS. 10A and 10B, at step 1011, a first electronic device 1001a, upon detecting a user gesture indicating that the user views the screen while a voice call, using a voice call application is in progress, may obtain a request for running a video sharing service. Alternatively, upon detecting an input of the user touching on a video sharing button displayed on a voice call execution screen while the voice call is in progress, the first electronic device 1001a may obtain the touch input as a request for running the video sharing service

At step 1012, the first electronic device 1001a may generate connection identification information (e.g., Group ID A+B+C) to provide a multilateral video sharing service to a second electronic device 1000b and a third electronic device 1000c which are opposite parties of the multilateral video sharing.

Meanwhile, at the same or a similar time as step 1011, at step 1021, the third electronic device 1001c upon detecting a user gesture indicating that the user views the screen while a voice call, using a voice call application is in progress, may obtain a request for running a video sharing service. Alternatively, upon detecting an input of the user touching on a video sharing button displayed on a voice call execution screen while the voice call is in progress, the third electronic device 1001c may obtain the touch input as a request for running the video sharing service

Further, at the same or a similar time as step 1012, at step 1022, the third electronic device 1001c may generate connection identification information (e.g., GroupID A+B+C) for the video sharing service.

At steps 1013 and 1014, a first external electronic device 1006 (e.g., the video sharing service server 406) may receive at the same or a similar time, an Initialize message containing the connection identification information, from the first electronic device 1001a and the third electronic device 1001c, for initiating a video sharing service. At steps 1014 and 1024, the first electronic device 1001a and the third electronic device 1001c may transmit at the same or a similar time, an Invite message containing the connection identification information, to the second external electronic device 1007 (e.g., a push server), to invite the second electronic device 1001b to join the video sharing service.

At step 1030, the first external electronic device 1006 may verify the integrity of the connection identification information received from the first electronic device 1001a and the third electronic device 1001c and determine a host of a video sharing service depending on the results of the verification. The first external electronic device 1006 may request the second external electronic device 1007 to transfer the result of the verification of the integrity to the third electronic device 1001c that is not determined to be the host.

At step 1025, the second external electronic device 1007 may transmit, to the third electronic device 1001c, a Status(Err#) message to notify the third electronic device 1001c that the third electronic device 1001c has not been determined to be the host according to the result of the verification of integrity.

At step 1026, the third electronic device 1001c may present a notification to the user indicating that the third electronic device 1001c is not determined to be the host.

In step 1027, the third electronic device 1001c may transmit, to the second external electronic device 1007, an Ack(Err#) message accepting the fact that the third electronic device 1001c is not determined to be the host.

At step 1031, the second external electronic device 1007 may transmit to the second electronic device 1001b by push, the Invite message received from the first electronic device 1001a.

At step 1032, the first external electronic device 1006 may transmit, to the first electronic device 1001a, an OnInitialized message for accepting a video sharing connection to provide the video sharing service.

At step 1033, the second external electronic device 1007 may transmit to the third electronic device 1001c by push, the Invite message received from the first electronic device 1001a.

At step 1034, the first external electronic device 1006 may transmit, to the first electronic device 1001a, an OnInitialized message for accepting a video sharing connection to provide a video sharing service.

At steps 1035 and 1036, the second electronic device 1001b may transmit, to the first external electronic device 1006, an Initialized message for initializing a video sharing service, corresponding to the received Invite message and receive, from the first external electronic device 1006, an OnInitialized message in response.

At steps 1037 and 1038, the third electronic device 1001c may transmit, to the first external electronic device 1006, an Initialized message for initializing a video sharing service, corresponding to the received Invite message and receive, from the first external electronic device 106, an OnInitialized message in response.

At step 1040, the first electronic device 1001a and the second electronic device 1001b may establish a video sharing connection for a video sharing service. Here, the video sharing connection may be a P2P connection that is directly made between the first electronic device 1001a and the second electronic device 1001b.

At steps 1041, 1042, 1043, 1044, 1045, and 1046, the first electronic device 1001a and the second electronic device 1001b may transmit and/or receive a message for the result of joining the video sharing service, a message requesting to initiate the video sharing, and a message accepting the request to initiate the video sharing.

A video sharing connection for the video sharing service of the third electronic device 1001c to the first electronic device 1001a may further be established, so that a multilateral video sharing connection may be established among the first electronic device 1001a, the second electronic device 1001b, and the third electronic device 1001c.

At steps 1051, 1052, 1053, 1054, 1056, and 1057, the first electronic device 1001a and the third electronic device 1001c may transmit and/or receive a message for the result of joining the video sharing service, a message requesting to initiate the video sharing, and a message accepting the request to initiate a video sharing.

According to an embodiment of the present disclosure, in operation 1060, the first electronic device 1001a, the second electronic device 1001b, and the third electronic device 1001c may receive the video sharing service.

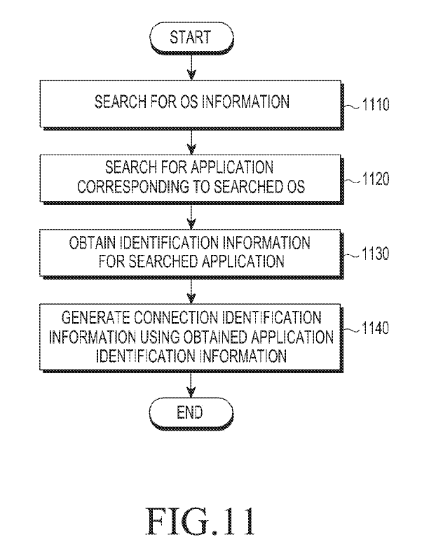

FIG. 11 is a flowchart of a method for operating a video sharing service, according to an embodiment of the present disclosure.

Referring to FIG. 11, the video sharing service relating to the operational method that may be performed in operations 610 and 620 of FIG. 6 is provided.

As shown in FIG. 11, in a video sharing service, connection identification information for the video sharing service may be generated by an electronic device. The connection identification information may be generated based on a designated rule in order to maintain inter-electronic device compatibility.

At step 1110, the electronic device may search for each OS to perform a video sharing service on an OS that may have a management policy for different applications, such as Android™, Linux™, or Tizen™. In searching for the OS of the opposite party's electronic device related to identification information for providing a video sharing service, an OS list may be received from a video sharing service server providing a video sharing service or a voice call application. For example, when a video sharing application is loaded on the electronic device, a request may be sent to the video sharing service providing the video sharing service, and an OS list necessary to use a video sharing service may be received. Further, the electronic device may receive information regarding the OS that the opposite party's electronic device is using through a communication connection via a voice call application. The voice call application may share the information regarding the electronic devices by communicating signals related to the communication connection.

In step 1120, the electronic device may search for an application corresponding to the found OS. The application for a video sharing service may be selected based on the OS information. For example, when users A, B, and C use different OSs, user B may play a role as an intermediate entity for a video sharing service for users A and B in order to support a multilateral video sharing.

At step 1130, when user B generates connection identification information for the video sharing service, the electronic device may provide, to the video sharing service server providing a video sharing service, application identification information (e.g., AppID) using the OS information for users A and C. The application identification information may be information that user B arbitrarily selects from the information regarding the list of multiple OSs. User B may transfer information necessary for a mutual connection to the video sharing service server so as to receive the video sharing service, i.e., receive information from users A and C using a video sharing service, or although not providing or receiving information from users A and C, to use a video sharing service between users A and C.

At step 1140, the electronic device may perform an additional verification operation on the application identification information. For example, the electronic device may verify the integrity of a command delivered through a push server that may be recognized by different OSs. The command used in an OS may be varied or deleted depending on the update state of the OS. Further, the video sharing application may be loaded on the electronic device, or when the background is operated, a varying OS command may be received from the outside, and then, the OS command stored in the electronic device may be varied or managed so that it may be used in the operation of generating connection identification information for the video sharing service. When the integrity of application identification information is verified through the OS command, connection identification information may be generated using the application identification information whose integrity has been verified.

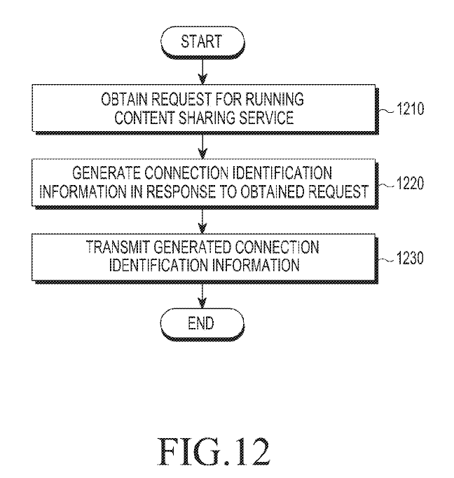

FIG. 12 is a flowchart of a method for operating a video sharing service, according to an embodiment of the present disclosure.

Referring to FIG. 12, at step 1210, the first electronic device 401a may obtain a request for running a content sharing service with the second electronic device 401b. For example, the first electronic device 401a, upon detecting a user gesture indicating that the user views the screen while a voice call using a voice call application is in progress, may obtain the user gesture as a request for running a video sharing service. Alternatively, upon detecting an input of the user touching on a video sharing button displayed on a voice call execution screen while the voice call is in progress, the first electronic device 401a may obtain the touch input as a request for running the video sharing service.

At step 1220, the first electronic device 401a may generate connection identification information using first user identification information corresponding to the first electronic device 401a and second user identification information corresponding to the second electronic device 401b in response to the obtained request. The connection identification information may be identification information for managing a video sharing connection so that a video sharing service may be provided between the first electronic device 401a and the second electronic device 401b. For example, the first user identification information and the second user identification information may be the respective phone numbers of the first electronic device 401a and the second electronic device 401b. Alternatively, the first user identification information and the second user identification information may be the respective unique device information (e.g., MAC addresses or serial numbers) of the first electronic device 401a and the second electronic device 401b.

At step 1030, the first electronic device 401a may transmit the generated connection identification information to the video sharing service server 406 for providing the content sharing service between the first electronic device 401a and the second electronic device 401b. For example, the first electronic device 401a may transmit the connection identification information, as at least a portion of an Initialize message for establishing a communication connection between the first electronic device 401a and the second electronic device 401b, to the video sharing service server 406. Alternatively, the first electronic device 401a may simultaneously transmit the connection identification information, as at least a portion of an Invite message, to a second external electronic device (e.g., a push server). The second external electronic device may transmit the Invite message to the first electronic device 401a.

According to an embodiment of the present disclosure, a method for sharing a content by an electronic device comprises obtaining, by a first electronic device, a request for running a content sharing service between the first electronic device and a second electronic device, generating connection identification information using first user identification information corresponding to the first electronic device and second user identification information corresponding to the second electronic device in response to the request, and transmitting the generated connection identification information to a first external electronic device for providing the content sharing service between the first electronic device and the second electronic device.

Generating the connection identification information may include generating the connection identification information using application identification information corresponding to an application for running the content sharing service.

The method may further comprise identifying, by the first electronic device, a third electronic device positioned near the first electronic device and transmitting a content to the third external electronic device so that the content may be provided by the content sharing service through the third external electronic device.

The method may further comprise obtaining third user identification information corresponding to the third electronic device and modifying the connection identification information based on the third user identification information.

A method for sharing a content by an electronic device comprises obtaining, by a first electronic device, a request for running a content sharing service between the first electronic device and a second electronic device, identifying first user identification information corresponding to the first electronic device and second user identification information corresponding to the second electronic device in response to the request, and transmitting the identified first user identification information and second user identification information to a first external electronic device for providing the content sharing service between the first electronic device and the second electronic device.

The method may further comprise identifying application identification information corresponding to an application for running the content sharing service and transmitting the identified application identification information, along with the first user identification information and the second user identification information, to the first external electronic device.

The method may further comprise identifying, by the first electronic device, a third electronic device positioned near the first electronic device and transmitting a content to the third external electronic device so that the content may be provided by the content sharing service through the third external electronic device.

The method may further comprise obtaining third user identification information corresponding to the third electronic device and transmitting the obtained third user identification information, along with the first user identification information and the second user identification information, to the first external electronic device.

Each of the aforementioned components of the electronic device may include one or more parts, and a name of the part may vary with the type of the electronic device. The electronic device in accordance with various embodiments of the present disclosure may include at least one of the aforementioned components, omit some of them, or include other additional components. Some of the components may be combined into a single entity, and the entity may perform the same functions as the components do.

The term “module” may refer to a unit including one of hardware, software, and firmware, or a combination thereof. The term “module” may be used interchangeably with the terms “unit”, “logic”, “logical block”, “component”, or “circuit”. The module may be a minimum unit or part of an integrated component. The module may be a minimum unit or part of performing one or more functions. The module may be implemented mechanically or electronically.

The module may include at least one of application specific integrated circuit (ASIC) chips, field programmable gate arrays (FPGAs), or programmable logic arrays (PLAs) that perform some operations, which have already been known or will be developed in the future.

At least a part of the electronic device (e.g., modules or their functions) or method (e.g., operations) may be implemented as instructions stored in a computer-readable storage medium e.g., in the form of a program module 301. The instructions, when executed by the processor 120, may enable the processor 120 to carry out a corresponding function. The computer-readable storage medium may be the memory 130.

The computer-readable medium may include a hard disk, a floppy disc, a magnetic medium (e.g., magnetic tape), an optical recording medium (e.g., CD-ROM, DVD, magneto-optical medium (e.g., floptical disk), or a hardware device (e.g., a read-only memory (ROM), a random-access memory (RAM), or a flash memory). Examples of the program instructions may include not only machine language codes but also high-level language codes which are executable by various computing means using an interpreter. The aforementioned hardware devices may be configured to operate as one or more software modules to carry out embodiments of the present disclosure, and vice versa.

Modules or programming modules in accordance with the embodiments of the present disclosure may include at least one or more of the aforementioned components, omit some of them, or further include other additional components. Operations performed by modules, programming modules or other components in accordance with the embodiments of the present disclosure may be carried out sequentially, simultaneously, repeatedly, or heuristically. Furthermore, some of the operations may be performed in a different order, or omitted, or include other additional operations.

There may be provided a storage medium which may store instructions configured to, when executed by a processor, instructs the processor to perform at least one operation that may include obtaining, by an electronic device, a request for running a content sharing service with a first external electronic device, generating connection identification information using first user identification information corresponding to the electronic device and second user identification information corresponding to the first external electronic device in response to the request, and transmitting the generated connection identification information to a second external electronic device for providing the content sharing service between the electronic device and the first electronic device.

Further, there may be provided a storage medium which may store instructions configured to, when executed by the processor, enable the processor to perform at least one operation that may include obtaining, by an electronic device, a request for running a content sharing service with a first external electronic device, identifying first user identification information corresponding to the electronic device and second user identification information corresponding to the first external electronic device in response to the request, and transmitting the identified first user identification information and second user identification information to a second external electronic device for providing the content sharing service between the electronic device and the first external electronic device.

The embodiments herein are provided merely for better understanding of the present disclosure, and the present disclosure should not be limited thereto. It should be appreciated by one of ordinary skill in the art that various changes in form or detail may be made to the embodiments without departing from the scope of the present disclosure, which is defined not by the detailed description and embodiments, but by the following claims and their equivalents.

What is claimed is:

1. A first electronic device, comprising:
a communication interface; and
a processor configured to:
obtain a request for running a content sharing service with a second electronic device,
generate connection identification information using first user identification information corresponding to the first electronic device and second user identification information corresponding to the second electronic device, in response to the request, and
transmit the connection identification information to a first external electronic device for providing the content sharing service between the first electronic device and the second electronic device, using the communication interface.

2. The first electronic device of claim 1, wherein the processor transmits the connection identification information to the first external electronic device, in an initialize message for establishing a communication connection between the first electronic device and the first external electronic device.

3. The first electronic device of claim 1, wherein the processor simultaneously transmits the connection identification information to a second external electronic device, in an invite message.

4. The first electronic device of claim 3, wherein the invite message is transmitted to the second electronic device through the second external electronic device.

5. The first electronic device of claim 1, wherein the processor generates the connection identification information using application identification information corresponding to an application for running the content sharing service.

6. The first electronic device of claim 1, further comprising:
a short-range communication interface,
wherein the processor identifies a third electronic device using the short-range communication interface, and transmits content to the third electronic device to be provided by the content sharing service through the third electronic device.

7. The first electronic device of claim 6, wherein the processor obtains third user identification information corresponding to the third electronic device, and modifies the connection identification information based on the third user identification information.

8. The first electronic device of claim 1, wherein the processor runs the content sharing service while the first electronic device and the second electronic device are in a voice call connection.

9. The first electronic device of claim 8, wherein the processor runs a voice call through a first application and runs the content sharing service through a second application.

10. A first electronic device, comprising:
a communication interface; and
a processor configured to:
obtain a request for running a content sharing service with a second electronic device,
identify first user identification information corresponding to the first electronic device and second user identification information corresponding to the second electronic device, in response to the request, and
transmit the first user identification information and the second user identification information to a first external electronic device for providing the content sharing service between the first electronic device and the second electronic device, using the communication interface.

11. The first electronic device of claim 10, wherein the processor transmits the first user identification information and the second user identification information to the first external electronic device, in an initialize message for establishing a communication connection between the first electronic device and the first external electronic device.

12. The first electronic device of claim 10, wherein the processor simultaneously transmits the first user identification information and the second user identification information to a second external electronic device, in an invite message.

13. The first electronic device of claim 12, wherein the invite message is transmitted to the second electronic device through the second external electronic device.

14. The first electronic device of claim 10, wherein the processor transmits application identification information corresponding to an application for running the content sharing service, along with the first user identification information and the second user identification information, to the first external electronic device.

15. The first electronic device of claim 10, further comprising:
a short-range communication interface,
wherein the processor identifies a third electronic device using the short-range communication interface, and transmits content to the third electronic device to be provided by the content sharing service through the third electronic device.

16. The first electronic device of claim 15, wherein the processor obtains third user identification information corresponding to the third electronic device, and transmits the third user identification information, along with the first user identification information and the second user identification information, to the first external electronic device.

17. A method, comprising:
obtaining, by a first electronic device, a request for running a content sharing service between the first electronic device and a second electronic device;
generating connection identification information using first user identification information corresponding to the first electronic device and second user identification information corresponding to the second electronic device. in response to the request; and
transmitting the generated connection identification information to a first external electronic device for providing the content sharing service between the first electronic device and the second electronic device.

18. The method of claim 17, wherein generating the connection identification information comprises generating the connection identification information using application identification information corresponding to an application for running the content sharing service.

19. The method of claim 17, further comprising:
identifying, by the first electronic device, a third electronic device positioned near the first electronic device; and
transmitting a content to the third electronic device to be provided by the content sharing service through the third electronic device.

20. The method of claim 19, further comprising:
obtaining third user identification information corresponding to the third electronic device; and
modifying the connection identification information based on the third user identification information.
